(19) United States
(12) Patent Application Publication
(10) Pub. No.: US 2015/0122560 A1
(43) Pub. Date: May 7, 2015

(54) MULTI-CAR TRACKLESS TRANSPORTATION SYSTEM

(71) Applicant: King Fahd University Of Petroleum And Minerals, Dhahran (SA)

(72) Inventor: MUHAMMAD E.S. ELRABAA, DHAHRAN (SA)

(73) Assignee: King Fahd University Of Petroleum And Minerals, Dhahran (SA)

(21) Appl. No.: 14/072,789

(22) Filed: Nov. 6, 2013

(51) Int. Cl. B62D 47/02; B62D 13/00; B62D 59/04

(52) U.S. Cl. CPC B62D 47/02; B62D 59/04; B62D 13/00
USPC 180/14.2

(57) ABSTRACT

The multi-car trackless transportation system includes a pilot car and at least one secondary car connected to one another in a manner similar to a conventional tram system or the like. Each of the cars is connected to adjacent cars by pivotal connectors. The pilot car and the at least one secondary car each include an individual motor, drive system and steering system. In order to develop a virtual tramway or path, the pilot car transmits instantaneous velocity and steering angles measurements to the secondary car. The secondary car then applies these signals so that it has an equivalent velocity and steering angle at the same location as the pilot car when the measurements were taken.

### BACKGROUND OF THE INVENTION

1. Field of the Invention

The present invention relates to transportation systems having interconnected cars, such as trams, for example, and particularly to a multi-car trackless transportation system where each car has its own motive and steering drive systems.

2. Description of the Related Art

Environmental concerns have made public transportation a prominent and promising alternative in most urban environments. In order to decrease overall emissions and energy expenditures, multi-car transportations systems, such as trams, connected buses, trains and the like, are of great interest. However, since such systems typically use a single driving vehicle, which then pulls a plurality of interconnected passive vehicles, such systems typically run on rails in order to control the path of the following, passive vehicles. However, the creation of new tracks, particularly in an urban environment, is costly, difficult and time consuming. It would obviously be desirable to provide the convenience and economy of such a multi-car transportation system without the necessity of laying tracks.

Thus, a multi-car trackless transportation system solving the aforementioned problems is desired.

### SUMMARY OF THE INVENTION

The multi-car trackless transportation system includes a pilot car and at least one secondary car connected to one another in a manner similar to a conventional tram system or the like. Each of the cars is connected to adjacent cars by pivotal connectors. The pilot car and the at least one secondary car each include an individual motor, drive system and steering system. In order to develop a virtual tramway or path, the pilot car transmits instantaneous velocity and steering angles measurements to the secondary car. The secondary car then applies these signals so that it has an equivalent velocity and steering angle at the same location as the pilot car when the measurements were taken.

The pilot car carries a transmitter for transmitting a steering signal based upon an angular steering position of the pilot car and a velocity signal based upon the velocity of the pilot car. The angular steering position sₚ and the velocity of the pilot car vₚ are instantaneously measured and transmitted at a sampling period Δt of Δt=1m(m)/vₚ(mm/s). The sₚ values are passed to the next car as a sequence of steering angle values. These sₚ values are constantly stored in a memory buffer in the secondary car. The secondary car then calculates the application interval (i.e., the time between two consecutive readings and applications of the sₚ values from the buffer) as Δtₐ=1(mm)/vₛ(mm/s), where vₛ is the instantaneous velocity of the secondary car. This generates the same sₚ values for the secondary car at the exact location as for the pilot car P.

These and other features of the present invention will become readily apparent upon further review of the following specification.

### BRIEF DESCRIPTION OF THE DRAWINGS

FIG. 1 is an environmental, perspective view of a multi-car trackless transportation system according to the present invention.

FIG. 2 is a block diagram illustrating system components of a pilot car and a first car of the multi-car trackless transportation system according to the present invention.

FIG. 3 is a block diagram illustrating individual components of a combined transceiver and controller of the first car of FIG. 2.

FIG. 4A illustrates an exemplary route traveled by the multi-car trackless transportation system according to the present invention.

FIG. 4B is a graph showing velocity as a function of time for the route of FIG. 4A.

FIG. 4C is a graph showing steering angle as a function of time for the route of FIG. 4A.

FIG. 4D is a graph showing steering angle as a function of location for the route of FIG. 4A.

Similar reference characters denote corresponding features consistently throughout the attached drawing.

### DETAILED DESCRIPTION OF THE PREFERRED EMBODIMENTS

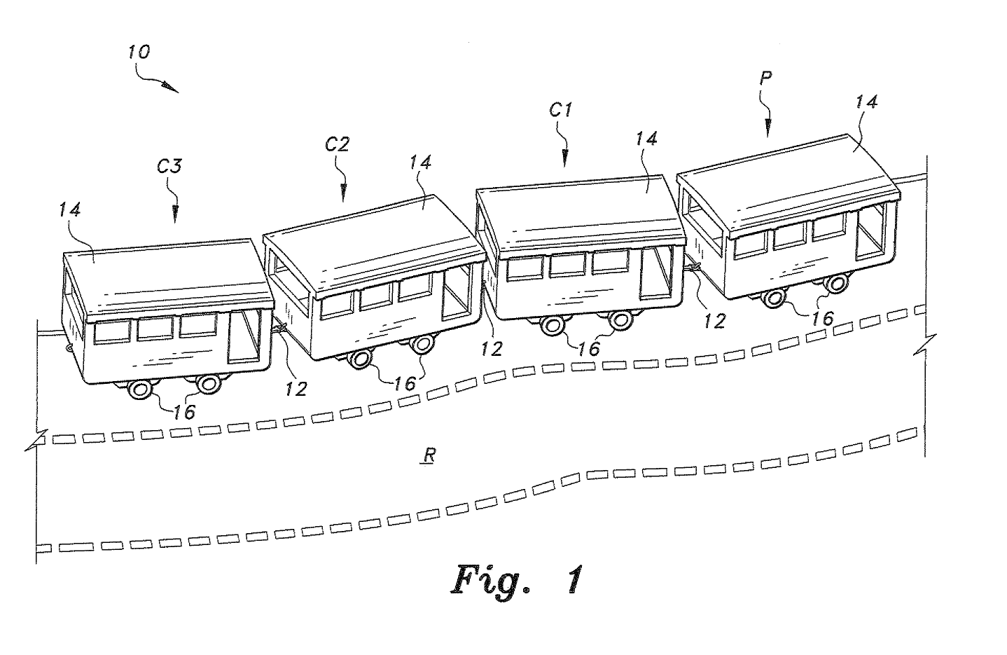

As shown in FIG. 1, the multi-car trackless transportation system 10 includes a pilot car P and at least one secondary car connected to one another in a manner similar to a conventional tram system or the like. In FIG. 1, three secondary cars C1, C2, and C3 are shown, although it should be understood that this is for illustrative purposes only, and that any desired number of secondary cars may be utilized. The pilot car P and each of the secondary cars C1, C2, C3 include a car body 14 and a plurality of wheels 16, as is conventionally known. Each of the cars P, C1, C2, C3 is connected to adjacent cars by pivotal connectors 12, as is also conventionally known. It should be understood that the overall configuration of the multi-car, tram-like system may be vary from that shown. An example of a conventional, articulated multi-car vehicle is shown in U.S. Pat. No. 3,246,714, which is hereby incorporated by reference in its entirety. As will be described in detail below, each of the cars has its own steering system and drive system. Thus, each connector 12 is preferably freely and rotationally joined on either end by a ball-and-socket joint or the like.

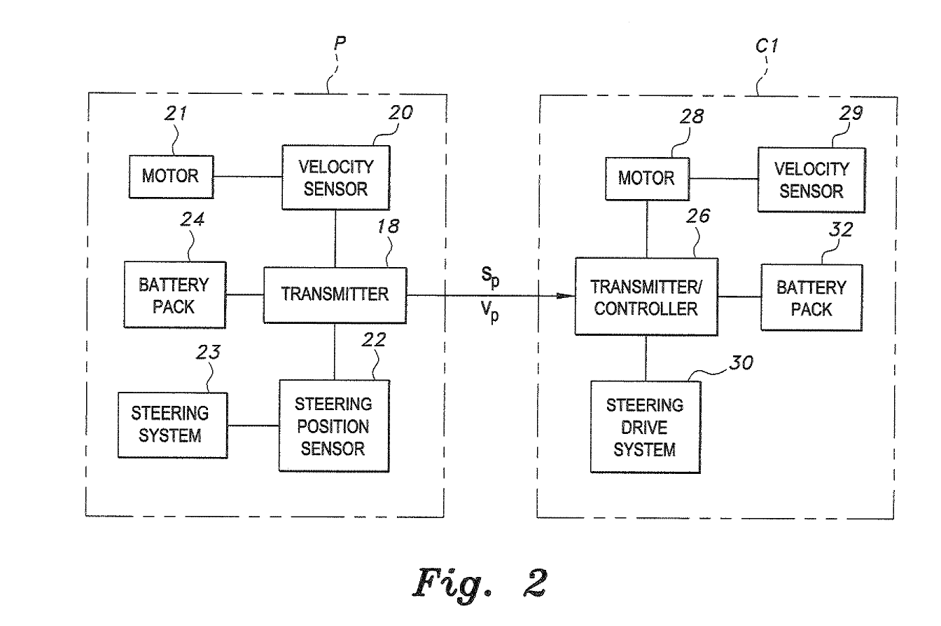

As illustrated in FIG. 2, the pilot car P includes a motor 21 for driving the plurality of wheels 16, coupled with a conventional drive train assembly or the like for selectively controlling the velocity of the pilot car P, and a conventional steering system 23 for selectively steering the pilot car P. The pilot car P is similar to a conventional lead or drive car in multi-car system, such as a conventional tram system or the like. Such a system is illustrated in U.S. Pat. No. 8,214,108, which is hereby incorporated by reference in its entirety. Although any type of motor or engine may be utilized, the motor 21 is preferably an electric motor, driven by a rechargeable battery pack 24. Preferably, the battery pack 24 includes a plurality of rechargeable individual batteries, which may be easily removed and replaced, so that recharging may take place off-vehicle, thus allowing a fresh battery to be quickly and easily inserted into the battery pack 24.

In addition to the conventional elements described above, the pilot car P also includes a velocity sensor 20 for measuring the instantaneous velocity of the pilot car P and a steering position sensor 22 for measuring the instantaneous steering angle of the pilot car P. The velocity sensor 20 and the steering position sensor 22 are coupled to a transmitter 18 for transmitting the measured velocity signal vₚ and the measured steering angle signal sₚ for the pilot car P to secondary car C1.

Each secondary car C1, C2, C3 includes a motor 28, similar to the motor 21 of the pilot car, for driving the plurality of wheels 16, similarly coupled with a conventional drive train assembly or the like for selectively controlling the velocity of the individual secondary car. Similarly, each secondary car includes a conventional steering system 30 for selectively steering the individual secondary car, similar to that of the pilot car P. As with the pilot car P, although any type of motor or engine may be utilized, the motor 28 is preferably an electric motor, driven by a rechargeable battery pack 32, similar to the battery pack 24 described above.

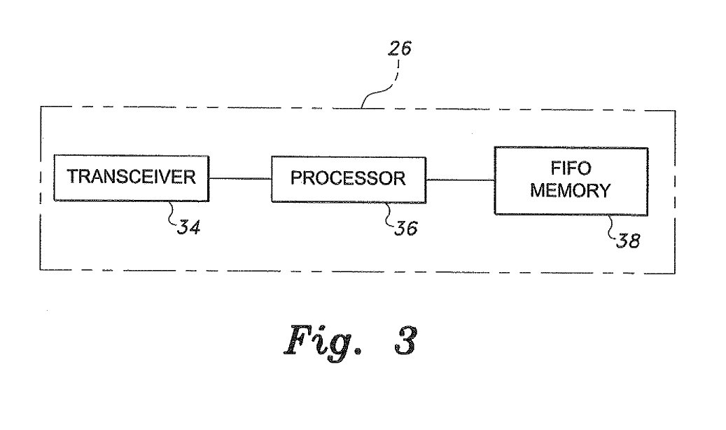

A combined transceiver/controller unit 26 receives the velocity signal vₚ and the steering angle signal sₚ for controlling the velocity and steering angle of secondary car C1. As shown in FIG. 3, the combined transceiver/controller unit 26 includes transceiver 34, a processor 36 and memory 38. It should be understood that the transmitter 18 and the transceiver 34 may be wireless or wired. If wired, preferably wireless signals are transmitted through cables or the like, which are carried by respective pivotal connectors 12 between the cars. The processor 36 may be any suitable type of processor, such as that found in a personal computer, a programmable logic controller or the like. Memory 38 may be any suitable type of computer readable memory acting as a storage buffer, such as first-in-first-out (FIFO) buffer memory or the like.

In use, the front wheels of each secondary car C1, C2, C3 replicate the steering position of the front wheels of the pilot car P for each location point along the traveled path, resulting in the generation of a virtual tramway or track that is followed by all cars in the overall tram system 10. This requires finding and storing a set of steering positions sₚ and corresponding locations for each car. The steering position sₚ is the measured steering angle of the front wheels. Each sₚ value is stored at fixed displacement steps of one centimeter, with an accuracy of ±1 mm. This tight control ensures that the error accumulated from one car to the next is negligible.

The fixed displacement steps require that only the values of the sₚ measurements need to be sampled, and the sampling period (i.e., the time between two consecutive samples) needs to be adjusted to the car's velocity. The accuracy required in velocity measurement is 1 mm/sec. Thus, for an instantaneous velocity of vₚ, the sampling period Δt is given as Δt=1(mm)/vₚ(mm/s).

The sₚ values are passed to the next car as a sequence of steering angle values. These sₚ values are constantly stored in FIFO buffer 38 in secondary car C1. The secondary car then calculates the application interval (i.e., the time between two consecutive readings and applications of the sₚ values from the FIFO buffer) as Δtₐ=1(mm)/vₛ(mm/s), where vₛ is the instantaneous velocity of the secondary car (measured by velocity sensor 29). This generates the same sₚ values for the secondary car at the exact location as for the pilot car P. Although the above has been described with respect to only the pilot car P and the first car C1, the same process is used between car C1 and car C2, car C2 and car C3, etc. It should be understood that other types of sensors (and corresponding signals) may be utilized, such as for braking, skidding, etc.

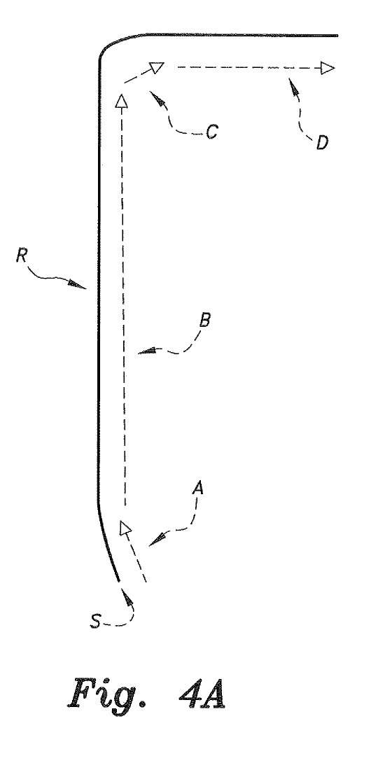

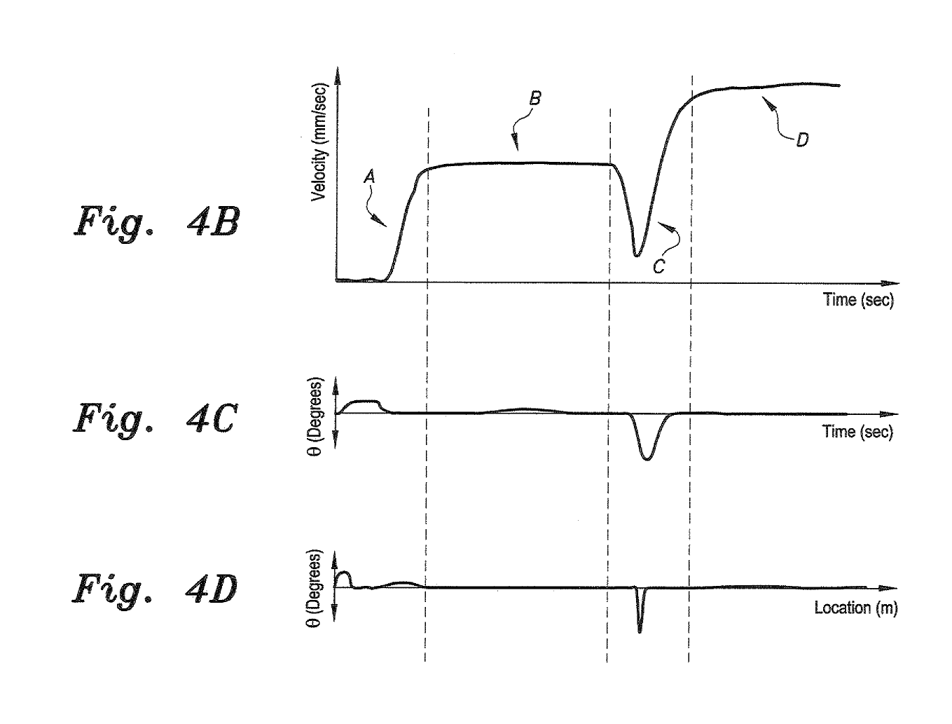

FIG. 4A illustrates a sample path taken by such a multi-car trackless transportation system 10. In region A, the system 10 pulls out of a station S and turns slightly left. Region B shows travel over a straight line path. In region C, the system 10 makes a right turn, leading into another straight line path D, where the system 10 accelerates. FIG. 4B is a graph showing this path (also divided into regions A, B, C and D) as a function of time. FIG. 4C shows the corresponding path for steering angle (measured in degrees) as a function of time, and FIG. 4D shows the same steering angle, but plotted as a function of location.

It is to be understood that the present invention is not limited to the embodiments described above, but encompasses any and all embodiments within the scope of the following claims.

I claim:

1. A multi-car trackless transportation system, comprising:
a pilot car having:
a pilot car body;
a plurality of wheels;
a motor for driving the plurality of wheels;
means for selectively controlling velocity of the pilot car;
means for selectively steering the pilot car; and
a transmitter for transmitting a steering signal based upon an angular steering position of the pilot car and a velocity signal based upon the velocity of the pilot car, wherein the angular steering position and the velocity of the pilot car vₚ are instantaneously measured and transmitted at a sampling period Δt, in seconds, of Δt=1(mm)/vₚ(mm/s);
at least one secondary car having:
a secondary car body;
a plurality of secondary wheels;
a secondary motor for driving the plurality of secondary wheels;
a transceiver for receiving the steering signal and the velocity signal;
buffer memory for storing the steering signal;
means for selectively controlling velocity of the at least one secondary car based upon the received velocity signal;
means for selectively steering the at least one secondary car based upon the received steering signal, wherein an application period Δtₐ between retrieval of the steering signal from the buffer memory and steering actuation is given in seconds as Δtₐ=1(mm)/vₛ(mm/s), where vₛ is an instantaneous velocity of the at least one secondary car; and
at least one pivotal connector pivotally connecting the pilot car body to the at least one secondary car body.

2. The multi-car trackless transportation system as recited in claim 1, wherein said pilot car further comprises a velocity sensor in communication with the transmitter.

3. The multi-car trackless transportation system as recited in claim 2, wherein said pilot car further comprises a steering angle sensor in communication with the transmitter.

4. The multi-car trackless transportation system as recited in claim 3, wherein said at least one secondary car further comprises a secondary velocity sensor in communication with the transceiver.
